(19) United States
(12) Patent Application Publication
(10) Pub. No.: US 2023/0408835 A1
(43) Pub. Date: Dec. 21, 2023

(54) STRUCTURED LIGHT GENERATION

(71) Applicant: ams Sensors Asia Pte. Ltd., Singapore (SG)

(72) Inventors: Gregor Schnitzler, Zollikerberg (CH); Nicola Spring, Ziegelbrücke (CH); Jens Geiger, Thalwil (CH)

(21) Appl. No.: 18/250,125

(22) PCT Filed: Dec. 14, 2021
(86) PCT No.: PCT/SG2021/050787

§ 371 Date: Apr. 21, 2023

(30) Foreign Application Priority Data
Dec. 17, 2020 (GB) 2019970.9

(51) Int. Cl. G02B 27/14; G02B 27/09

(52) U.S. Cl. CPC G02B 27/143; G02B 27/0961; G02B 27/0093; G02B 27/0916; G02B 27/145; G02B 27/144

(57) ABSTRACT

A system (100) for producing structured light, the system comprising an emitter (102) configured to provide a beam of light, and a first reflecting element (104). The emitter (102) and the first reflecting element (104) are separated from one another in a direction that is generally perpendicular to beams of light that are emitted from the system when in use. The first reflecting element (102) comprises a plurality of reflective surfaces oriented in different directions.

### TECHNICAL FIELD

The disclosure relates to the generation of structured light and patterned illumination, and corresponding apparatus for producing structured light, in particular for depth mapping purposes.

### BACKGROUND

The present disclosure relates to a system for generating structured light.

Structured light can be used to determine distances to objects. Objects can be distinguished according to their distance from an apparatus emitting the structured light, using a pattern created by the structured light.

Mobile phones may use a depth mapping to detect and identify the facial features of a specific user and consequently unlock the phone for access to the user. It is an aim of the present disclosure to provide an alternative system for generating structured light. It may be desirable to generate structured light in a manner that does not form part of the state of the art.

### SUMMARY

In general, this disclosure proposes to generate structured light using a system with an emitter and a reflecting surface. The system may use a plurality of reflective surfaces or an array of microlenses for generating a pattern of structured light.

Aspects and preferred features are set out in the accompanying claims.

According to a first aspect of the present disclosure, there is provided a system for producing structured light, the system comprising an emitter configured to provide a beam of light, and a first reflecting element comprising a plurality of reflective surfaces oriented in different directions, wherein the emitter and the first reflecting element are separated from one another in a direction which is generally perpendicular to beams of light that are emitted from the system when in use.

A light beam is provided from the emitter, and reflected in a plurality of different directions by the reflective surfaces of the first reflecting element. This produces a pattern of structured light: for example, a dot pattern. Embodiments of the invention may be easier and/or cheaper to implement than conventional systems for producing structured light. Furthermore, the system does not require a patterned slide or an imaging lens for achieving a patterned illumination.

The emitter may be configured to emit a single beam of light. The emitter may be a light emitting diode (LED). Alternatively, the emitter may be an array of lasers (e.g. vertical cavity surface emitting lasers (VSCELs). Where this is the case, the emitter may further comprise an optical diffuser configured to merge light from the array of lasers into a single beam. The emitter may be a single laser, provided that a beam from the laser has a sufficiently large cross-sectional area (or that optics are provided which expand the cross-sectional area of the beam). The beam of light provided by the emitter may be sufficiently large that light from the laser is incident on the plurality of reflective surfaces. The light provided by the emitter need not necessarily be incident on all of the reflective surfaces, but should be incident upon a majority of the reflective surfaces.

Using an LED may be preferred because it will provide better eye safety for users compared to systems using a laser or array of lasers. An LED may also be cheaper than using a laser or array of lasers.

According to a further aspect of the disclosure, there is provided a system for producing structured light, the system comprising an emitter configured to emit multiple beams of light at a wavelength L, a first reflecting element, and an array of microlenses which are arranged at a lens pitch P, wherein, in use, light travels a distance D between the emitter and the array of microlenses and, wherein P2=2 LD/N and wherein N is an integer with N≥1, and wherein the emitter and the first reflecting element are separated from one another in a direction which is generally perpendicular to beams of light that are emitted from the system when in use.

The array of microlenses and the first reflecting element may be separated from each other in a direction which is generally parallel to beams of light that are emitted from the system when in use.

The light beams emitted are refracted and/or diffracted by the array of microlenses which produces a pattern of structured light; for example, a dot pattern. By providing the lens pitch P and the distance D between the emitter and the array of microlenses such that P²=2 LD/N, a pattern of particularly high contrast can be projected into a scene.

The integer N can be varied such that the emitter and the array of microlenses are separated by a distance D which is an integer multiple of P²/2 L. A greater number of dots are generated for an increased distance D, where D satisfies the equation P²=2 LD/N.

By providing a reflecting element between the emitter and the array of microlenses, a folded beam path is used and the distance D can be increased with a resulting increase in integer N. This increases the number of dots generated whilst avoiding increasing the height of the system. The integer N may for example be 2 or more. The integer N may for example be 3 or more.

The structured light is generated from an interference pattern created by interference of light propagating from the different microlenses of the array of microlenses. This means that the contrast of the structured light remains substantially constant over a wide range of distances from the microlens array, usually in the whole far field, which is at least from, e.g., 5 cm or 10 cm to infinity. The system does not require a patterned slide or an imaging lens for achieving a patterned illumination.

Wavelengths L may in particular be in an invisible range of light, particular in the infrared light range.

The microlenses may be refractive microlenses. The microlenses may be collecting lenses (converging lenses), e.g., convex lenses, or may be dispersing lenses, e.g., concave lenses.

The microlenses may be provided on an exit window of the system. The microlenses may be formed on an inner surface of the exit window. This advantageously means that damage such as scratches to the exit window will not affect the microlenses.

The emitter may comprise an array of light sources for emitting light of a wavelength L each and having an aperture each, wherein the apertures are located in a common emission plane, which is located at the distance D from the array of reflective microlenses. The array of light sources may be a laser array such as a VCSEL array.

The apertures do not need to be separable from the light sources. E.g., for a semiconductor laser, the active area from which the light is emitted establishes the aperture.

The emitter and the first reflecting element may be completely enclosed with a package.

The first reflecting element may be partially transmissive. A partially transmissive reflecting element may be transmissive to at least a portion of the light incident upon on the reflecting element, and may reflect at least a portion of the light emitted from the emitter. The first reflecting element may be transparent to at least a portion of the light emitted from the emitter such that light emitted from the emitter may propagate, at least in part, through the first reflecting element. The system may further comprise an optical detector (such as a photodiode) arranged to detect emitted light transmitted through the first reflecting element. The emitter may be located on a first side of the first reflecting element and the optical detector may be arranged on a second side of the first reflecting element. This allows light (for example from the emitter or from outside the system) to pass through the first reflecting element and to the photodiode behind the reflecting element. Changes in light or the amount of light received at the photodiode can be monitored. These changes can be used to identify when the system has been damaged or the emitter is emitting light that would be dangerous to a user, thus providing a means for monitoring the eye safety of a user that is easy to implement.

The emitter may be configured to emit light in a direction which is generally parallel to beams of light that are emitted from the system in use, and the may system further comprise a second reflecting element. Where this is the case, light emitted from the emitter is first reflected via the second reflecting element and then by the first reflecting element.

Alternatively, the emitter may be configured to emit light in a direction which is generally perpendicular to beams of light that are emitted from the system in use. As light is emitted from the emitter perpendicular to beams of light that are emitted from the system in use, the second reflecting element is not required. This reduces the cost of the system, and may also allow a system with a smaller depth.

Features of different aspects of the disclosure may be combined together.

Embodiments of this disclosure advantageously provide structured light.

The system disclosed herein utilises a novel approach at least in that first reflecting element and an emitter are provided, that are separated from one another in a direction which is generally perpendicular to beams of light that are emitted from the system when in use.

### BRIEF DESCRIPTION OF THE DRAWINGS

Some embodiments of the disclosure will now be described, by way of example only and with reference to the accompanying drawings, in which:

FIG. 1 illustrates a schematic cross-section of a system for producing structured light; and

FIG. 2 illustrates a schematic cross section of an alternative system from producing structured light.

### DETAILED DESCRIPTION OF THE PREFERRED EMBODIMENTS

Generally speaking, the disclosure provides a system for producing structured light that has an emitter and a first reflecting element, where the emitter and the first reflecting element are separated from one another in a direction which is generally perpendicular to beams of light that are emitted from the system when in use.

Some examples of the solution are given in the accompanying Figures.

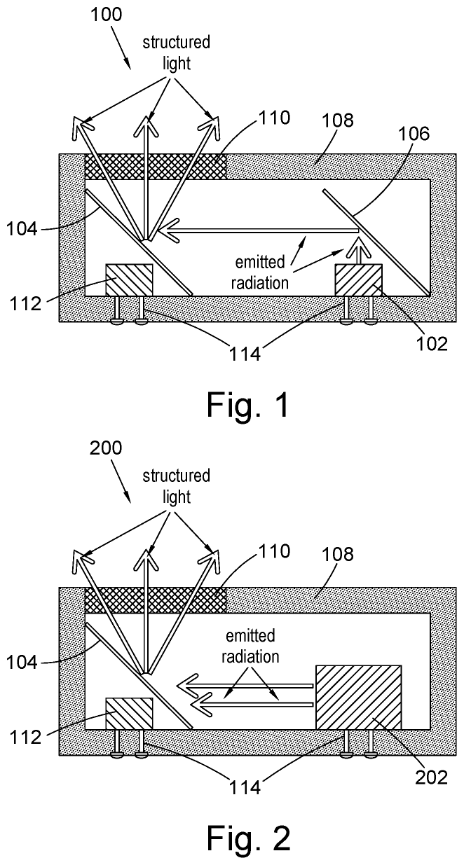

FIG. 1 illustrates a schematic cross-section of a system 100 for producing structured light. The system includes an emitter 102, a first reflecting element 104, and a second reflecting element 106. The emitter 102, and the first and second reflecting elements 104, 106 are completely enclosed within a packaging 108 having an exit window 110. The exit window 110 can be a glass plate that protects the components of the system inside the packaging 108. The second reflecting element 106 is a reflecting surface, such as a mirror, that reflects the light from the emitter in a direction towards the first reflecting element. In use, light is emitted from the emitter 102 and is then reflected by the second and first reflecting elements 104, 106 in turn before exiting the system 100 from the exit window 110. The light is emitted from the emitter 102 in a direction parallel to the direction that the structured light exits the system 100. The emitter 102 and the first reflecting element 104 are laterally spaced apart from each other in the packaging, in a direction generally perpendicular to the direction that the structured light exits the system. This allows light emitted from the emitter 102 to travel a greater distance through the system before exiting from the exit window 110. This allows a system that can be produced to be shallower in the direction of light emitted from the system, and is thus smaller and more compact.

In one example, the emitter 102 can be a light source that emits a single beam of light, such as an LED. In this example, the first reflecting element 104 can include a plurality of reflective surfaces that are oriented in different directions. The plurality of reflective surfaces can be provided by a mirror with many facets, which reflect in different directions. The emitted light is reflected in different directions by the surfaces of the first reflecting element 104 to form individual dots within a structured light pattern.

In another example, the emitter 102 comprises an array of light sources, such as an array of vertical cavity surface emitting lasers (VCSELs) and the first reflecting element 104 is a reflecting surface, such as a mirror, that reflects the light from the second reflecting element 106 in a direction towards the exit window 110. The VCSEL array is an array of light sources having an aperture each where the apertures are located on a common emission plane.

In this example, a microlens array is located on the exit window 110 (e.g. on an inner surface of the exit window 110). By providing the microlens array on the inner surface of the exit window 110, the microlens array is on the interior of the system and is protected by the exit window 110.

The emitter and the microlens array are configured such that P²=2 LD/N, where the emitter is configured to emit multiple beams of light at wavelength L, the array of microlenses are arranged at a lens pitch P, the array of microlenses is located at a distance D from the emitter, and where N is an integer with N≥1. When this condition is met, a structured light pattern is formed in which the contrast of the structured light is strong, and patterns of high contrast can be projected onto a scene.

Further information may be found in U.S. Pat. No. 10,509,147, which is herein incorporated by reference.

In this example, light from sources on the right hand side of the VSCEL array (as shown in the view of FIG. 1) will travel the same distance D from the emitter 102 to the microlens array on the exit window 110 compared to light from sources on the left hand side of the VSCEL array. Therefore, the lens pitch P can be constant across the array of microlenses. In an example system, the resulting distance D is approx. 1.2 mm for a wavelength of 940 nm. Other distances D will apply for other wavelengths (embodiments of the invention may be used for example at other infrared wavelengths).

By providing a reflecting element 104 between the emitter 102 and the array of microlenses in the exit window 110, a folded beam path is used and the distance D can be increased with a resulting increase in integer N. This increases the number of dots of a structured light pattern that are generated whilst avoiding increasing the height of the system. The integer N may for example be 2 or more, and may for example be 3 or more.

Each light source of the array of light sources illuminates several microlenses of the microlens array. Light emitted from a single light source of the array of light sources, but having been refracted by several microlenses can interfere so as to produce an interference pattern. Light emitted from another one of the light sources of the array of light sources produces, in the same way, the same interference pattern, such that, in the far field, all the interference patterns superimpose. In this manner, the structured light produces a high-intensity interference pattern.

The system includes an optical detector 112, such as a photodiode. The first reflecting element 104 (e.g. plurality of reflective surfaces or a reflecting surface) is partially transmissive. This is so that a portion of the light emitted from the emitter 102 and light from outside the system packaging 108 is incident on the first reflecting element 104 and transmitted through the first reflecting element 104 to the optical detector 112. This allows changes in the amount of light detected by the optical detector 112 to be monitored to indicate damage to the system or a malfunction that could be damaging to a user's eyes.

A lower surface of the packaging 108 can be a printed circuit board (PCB) formed of a copper plate. The photodiode 112 and the emitter 102 may be connected to electrical connections 114 on an outer surface of the PCB of the packaging. The photodiode 102 and the emitter 102 can be soldered onto the PCB.

FIG. 2 illustrates a schematic cross section of an alternative system 200 for producing structured light. In the system of FIG. 2, the emitter 202 is configured to emit light in a direction generally perpendicular to the direction that the structured light exits the system 200. In use, light is emitted from the emitter 102 and is then reflected by the first reflecting element 104 before exiting the system 200 from the exit window 110. Similar to the system shown in FIG. 1, the emitter 202 and the first reflecting element 104 are laterally spaced apart from each other in the packaging in a direction perpendicular to the direction that the structured light exits the system 200, such that light emitted from the emitter 202 travels laterally through the system before exiting from the exit window 110. This allows a system that is smaller and more compact. Furthermore, in the system of FIG. 2, because the emitter emits light in a direction towards the first reflecting element, a second reflecting element is not required. This reduces the cost of the system.

In one example, the emitter 202 can be a light source that emits a single beam of light perpendicular to the direction that light exits the exit window 110 and perpendicular to the lower surface of the packaging, such as a side emitting LED. In this example and similar to that discussed above, the first reflecting element 104 can include a plurality of reflective surfaces that are oriented in different directions, such as a mirror with many facets, which reflect in different directions. The emitted light is reflected in different directions by the surfaces of the first reflecting element 104 to form individual dots within a structured light pattern.

In a further example, the emitter 202 comprises an array of light sources, such as an array of vertical cavity surface emitting lasers (VCSELs) configured to emit light in a direction perpendicular to the direction that light exits the exit window 110 and perpendicular to the lower surface of the packaging, such as a side emitting LED. The first reflecting element 104 is a reflecting surface, such as a mirror, that reflects the light from the second reflecting element 106 in a direction towards the exit window 110. In this example, a microlens array is located on a lower surface of the exit window 110.

The emitter and the microlens array are configured such that P²=2 LD/N, where the emitter is configured to emit multiple beams of light at wavelength L, the array of reflective microlenses are arranged at a lens pitch P, the array of reflective microlenses is located at a distance D from the emitter, and where N is an integer with N≥1. When this condition is met, a structured light pattern is formed in which the contrast of the structured light is strong, and patterns of high contrast can be projected onto a scene.

In this example, light from sources towards the upper surface of the VSCEL array (as shown in the view of FIG. 1) will travel the same distance D from the emitter 102 to the microlens array on the exit window 110 compared to light from sources towards the lower surface of the VSCEL array. Therefore, the lens pitch P can be constant across the array of microlenses.

Some of the above-described embodiments use a reflecting element with a plurality of reflective surfaces in combination with an emitter that provides a single beam of light. The emitter may be a light emitting diode (LED). Alternatively, the emitter may be an array of lasers (e.g. vertical cavity surface emitting lasers (VSCELs). Where this is the case, the emitter may further comprise an optical diffuser configured to merge light from the array of lasers into a single beam (so that the emitter provides a single beam of light). Referring to FIG. 2 for example, a diffuser (not depicted) may be located between the emitter 202 and the first reflecting element 104. The diffuser may comprise glass with a rough surface, or glass provided with some other structure which diffuses light. The emitter may be a single laser, provided that a beam from the laser has a sufficiently large cross-sectional area (or that optics are provided which expand the cross-sectional area of the beam). The beam of light provided by the emitter may be sufficiently large that light from the laser is incident on the plurality of reflective surfaces of the first reflecting element 104. The light provided from the emitter need not necessarily be incident on all of the reflective surfaces, but should be incident upon a majority of the reflective surfaces. Using an LED for embodiments in which a single beam of light is used may be preferred, because it will provide better eye safety for users compared to systems using a laser or array of lasers. An LED may also be cheaper than using a laser or array of lasers.

The packaging 108, 208 and components within the packaging may be referred to as a module.

A system according to an embodiment of the invention may be provided in a smart phone or other portable computing device. The system may be used as a structured light source for facial recognition via depth mapping of a face (e.g. to determine whether a user is an authorized user of a smart phone or other portable computing device).

### LIST OF REFERENCE NUMERALS USED

100. System for producing structured light
102. Emitter
104. First reflecting element
106. Second reflecting element
108. Packaging
110. Exit Window
112. Optical Detector
114. Electrical Connections
200. Alternative system for producing structured light
202. Side emitter

The skilled person will understand that in the preceding description and appended claims, positional terms such as ‘above’, ‘overlap’, ‘under’, ‘lateral’, etc. are made with reference to conceptual illustrations of an apparatus, such as those showing standard cross-sectional perspectives and those shown in the appended drawings. These terms are used for ease of reference but are not intended to be of limiting nature. These terms are therefore to be understood as referring to a system when in an orientation as shown in the accompanying drawings.

The skilled person will understand that the term “comprising” does not exclude other elements or steps, that the term “a” or “an” when describing a feature does not exclude a plurality of the given feature, that a single component may fulfil the functions of several means recited in the claims, and that features recited in separate dependent claims may be combined. The skilled person will also understand that any reference signs in the claims should not be construed as limiting the scope.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in the disclosure, whether alone or in any appropriate combination with any other feature disclosed or illustrated herein.

1. A system for producing structured light, the system comprising:
an emitter configured to provide a beam of light, and a first reflecting element comprising a plurality of reflective surfaces oriented in different directions;
wherein the emitter and the first reflecting element are separated from one another in a direction which is generally perpendicular to beams of light that are emitted from the system when in use.

2. A system for producing structured light, the system comprising:
an emitter configured to emit multiple beams of light at a wavelength L, a first reflecting element, and an array of microlenses which are arranged at a lens pitch P,
wherein, in use, light travels a distance D between the emitter and the array of microlenses and, wherein P²=2 LD/N and wherein N is an integer with N≥1, and
wherein the emitter and the first reflecting element are separated from one another in a direction which is generally perpendicular to beams of light that are emitted from the system when in use.

3. A system according to claim 2, wherein the array of microlenses and the first reflecting element are separated from each other in a direction which is generally parallel to beams of light that are emitted from the system when in use.

4. A system according to claim 3, wherein the array of microlenses is formed in an exit window of the system.

5. A system according to claim 4, wherein the array of microlenses is formed on an inner surface of the exit window of the system.

6. A system according to claim 3, wherein the integer N is 2 or more.

7. A system according to claim 1, wherein the emitter is configured to emit a single beam of light.

8. A system according to claim 7, wherein the emitter is a light emitting diode (LED).

9. A system according to claim 1, wherein the emitter comprises a laser configured to emit multiple beams of light and a diffuser configured to combine the multiple beams into a single beam.

10. A system according to claim 2, wherein the emitter comprises an array of light sources for emitting light of a wavelength L each and having an aperture each, wherein the apertures are located in a common emission plane, which is located at the distance D from the array of reflective microlenses.

11. A system according to claim 1, wherein the first reflecting element is partially transmissive.

12. A system according to claim 11, wherein the system further comprises an optical detector arranged to detect light transmitted through the first reflecting element.

13. A system according to claim 12, wherein emitter is located on a first side of the first reflecting element and wherein the optical detector is arranged on a second side of the first reflecting element.

14. A system according to claim 2, wherein the first reflecting element is partially transmissive.

15. A system according to claim 14, wherein the system further comprises an optical detector arranged to detect light transmitted through the first reflecting element.

16. A system according to claim 15, wherein emitter is located on a first side of the first reflecting element and wherein the optical detector is arranged on a second side of the first reflecting element.

17. A system according to claim 1, wherein the emitter is configured to emit light in a direction which is generally parallel to beams of light that are emitted from the system in use, and wherein the system further comprises a second reflecting element.

18. A system according to claim 1, wherein the emitter is configured to emit light in a direction which is generally perpendicular to beams of light that are emitted from the system in use.

19. A system according to claim 2, wherein the emitter is configured to emit light in a direction which is generally parallel to beams of light that are emitted from the system in use, and wherein the system further comprises a second reflecting element.

20. A system according to claim 2, wherein the emitter is configured to emit light in a direction which is generally perpendicular to beams of light that are emitted from the system in use.
